(19) United States
(12) Patent Application Publication
(10) Pub. No.: US 2012/0244258 A1
(43) Pub. Date: Sep. 27, 2012

(54) CONFECTIONERY PRODUCT CONTAINING ACTIVE INGREDIENTS

(75) Inventor: Stephanie Von Niessen, Schwaebisch Gmuend (DE)

(73) Assignee: FUNFOODS K.S., Sahy (SK)

(21) Appl. No.: 13/514,451

(22) PCT Filed: Dec. 8, 2010
(86) PCT No.: PCT/EP2010/007448

§ 371 Date: Jun. 7, 2012

(30) Foreign Application Priority Data
Dec. 8, 2009 (DE) 102009057261.9

(51) Int. Cl. A23G 1/54; A23G 3/54; A23G 3/42; A23G 3/48; A23G 3/44; A23G 1/44

(52) U.S. Cl. 426/94; 426/103; 426/283

(57) ABSTRACT

A nutritional product includes a shell and a core that is at least partially covered by the shell. The shell contains a fat-and-carbohydrate mixture. The core has a gel-like consistency. Based on a total weight of the core, the core includes: a) a protein component of 0.5 to 10 wt-%; b) a carbohydrate component of 65 to 82 wt-% in the form of a crystalline and a non-crystalline carbohydrate phase; and c) water from 10 to 30 wt-%.

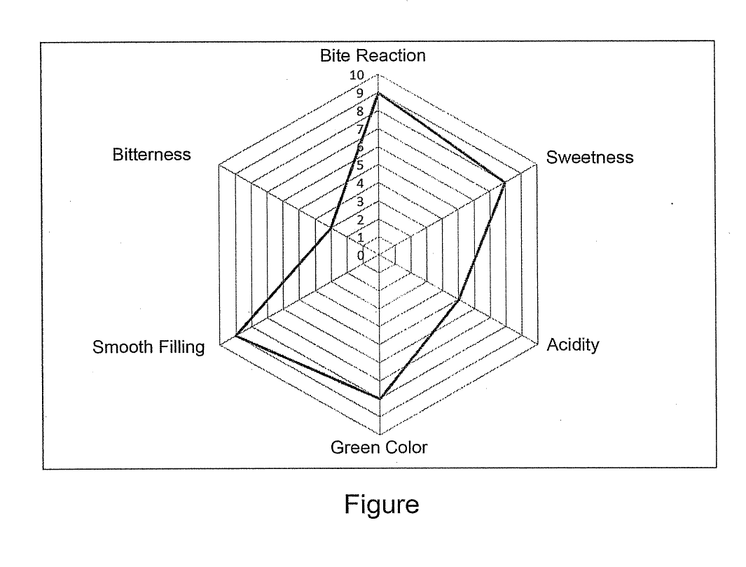

The present invention relates to a nutritional product and a method for the production thereof.

Foods which do not just cover the energy and nutrient requirements of a body, but also fulfil other functions, are well known. In addition to coffee-containing beverages and gels, such foods include chocolate bars and energy bars which provide consumers with a vitalizing effect in addition to an interesting taste.

For example, chocolate products in the form of bars, pralines, or filled chocolates are known from DE 199 40 747 A1, the chocolate products comprising a chocolate shell and a cookie-like insert, wherein a caffeine-containing mixture is integrated into the cookie-like insert. This product is intended to raise mental and psychological performance.

From WO 03/079818 A1, food compositions are known which comprise carbohydrates, fats and proteins, wherein these products also comprise caffeine to increase the mental receptiveness of a consumer.

From US 2008/0050472 A1 and BE 101 657 3 A6, food supplements and foods are known which can contain caffeine and/or taurine. The patents disclose the use of such stimulants, in particular in energy drinks, and also in gels or bars.

US 2007/0172542 A1 discloses nutritional bars comprising stimulants such as green tea extracts, ginseng, taurine, caffeine and/or synephrine in an amount of up to 0.16 wt-%. The stimulants used in these bars must be at least partially provided with a coating, preferably a fat-containing coating, in order to prevent any residual unpleasant, bitter taste in ready-to-eat products caused by the stimulants. In order to prevent the coating of the stimulants from dissolving away prematurely during chewing, the composition of the bar must have a creamy structure that makes it easier to chew.

The technical problem underlying the present invention involves providing a nutritional product that overcomes the above disadvantages, in particular to provide an organoleptic, in particular attractive nutritional product with respect to taste and appearance in as simple and cost-effective a form as possible, said product not having any taste perceived as unfavorable by consumers, for example due to the stimulants used, and having an effect that is stimulating to consumers, and moreover having improved technical characteristics, in particular having good storage stability.

The present invention solves this underlying technical problem by providing a nutritional product according to the main claim. In particular, the present invention solves this underlying technical problem by providing a nutritional product comprising a shell containing a fat-and-carbohydrate mixture and a core which is at least partially covered by the shell, wherein the core exists in a gel-like consistency and comprises an amount (each total weight of component being based on the total weight of the core) of a) a protein component of 0.5 to 10 wt-%, b) a carbohydrate component existing in the form of a crystalline and a non-crystalline carbohydrate phase of 65 to 82 wt-% and c) water from 10 to 30 wt-%.

In an especially preferred embodiment, the nutritional product in the core comprises 0.2 to 8.0 wt-%, in particular 0.3 to 6.0 wt-%, preferably 0.35 to 4.0 wt-%, of a caffeine-containing stimulant component, in other words a stimulant or a stimulant mixture, in particular the stimulant caffeine. In an especially preferred embodiment, the caffeine-containing component can exist in the form of caffeine, guarana, coffee extract or cola nut powder. In an especially preferred embodiment, 0.3 to 6.0 wt-%, preferably 0.35 to 4.0 wt-%, caffeine is used as the stimulant component. In an especially preferred embodiment, the caffeine-containing stimulant component also comprises at least one non-caffeine-based stimulant selected from the group consisting of taurine and theobromine. In another preferred embodiment, 0.3 to 6.0 wt-%, preferably 0.35 to 4.0 wt-%, of a caffeine-containing stimulant component in the form of a stimulant mixture of caffeine and taurine or caffeine and theobromine is used. In an especially preferred embodiment, the stimulant is guarana. In an especially preferred embodiment, the guarana can be used in liquid or powdered form. In an especially preferred embodiment, the stimulant is synthetic caffeine. In an especially preferred embodiment, the stimulant is coffee extract. In an especially preferred embodiment, the stimulant is cola nut powder.

In an especially preferred embodiment, the crystalline carbohydrate phase comprises saccharose and glucose, and preferably consists of them. In another preferred embodiment, the crystalline carbohydrate phase comprises saccharose and isomaltulose, and is preferably consists of them. In another preferred embodiment, the crystalline carbohydrate phase comprises glucose and isomaltulose, and is preferably consists of them. In another preferred embodiment, the crystalline carbohydrate phase comprises saccharose, glucose and isomaltulose, and is preferably consists of them. In a preferred embodiment, the non-crystalline carbohydrate phase is made up of glucose syrup and optionally water, preferably it consists of them or it.

In an especially preferred embodiment, the invention provides that the carbohydrate component comprises 60 to 90 wt-%, preferably 70 to 80 wt-%, in particular 75 to 80 wt-% crystalline carbohydrate phase (the weight of the crystalline phase is based on the weight of the dry matter of the carbohydrate component).

In another preferred embodiment, the carbohydrate component comprises 40 to 10 wt-%, preferably 30 to 20 wt-%, in particular 25 to 20 wt-% non-crystalline carbohydrate phase (the weight of the dry matter of the non-crystalline phase is based on the weight of the dry matter of the carbohydrate component).

In an especially preferred embodiment, the wt-% fraction of saccharose in the crystalline carbohydrate phase is from 40 to 45, in particular 41 to 44 (the weight of the sugar is based on the total weight of the core). In a preferred embodiment, the wt-% fraction of glucose in the crystalline carbohydrate phase is from 6 to 9, in particular 5 to 8 (the weight of the sugar is based on the total weight of the core).

In a preferred embodiment, 0 to 5, in particular 1 to 5 wt-% of the saccharose fraction of the crystalline carbohydrate phase is preferably replaced by the same amount of isomaltulose.

In a preferred embodiment, the wt-% fraction (the saccharose weight is based on the total weight of the crystalline carbohydrate phase) of saccharose in the crystalline carbohydrate phase is from 75 to 92 wt-%, in particular 78 to 88 wt-%.

In a preferred embodiment, the wt-% fraction (the isomaltulose weight is based on the total weight of the crystalline carbohydrate phase) of isomaltulose in the crystalline carbohydrate phase is from 0 to 10 wt-%, in particular 1 to 9 wt-%, preferably 2 to 8 wt-%.

In a preferred embodiment, the wt-% fraction (the glucose weight is based on the total weight of the crystalline carbohydrate phase) of glucose in the crystalline carbohydrate phase is from 5 to 25 wt-%, preferably 8 to 18 wt-%.

The non-crystalline carbohydrate phase can exist in the form of a syrup, in particular an aqueous syrup and includes water in this embodiment in addition to the amounts in the core identified in feature c).

In an especially preferred embodiment, the non-crystalline carbohydrate phase used according to the invention exists with a dry matter content of 60 to 90 wt-%, preferably 65 to 85 wt-%, in particular 70 to 85 wt-%.

In an especially preferred embodiment, the core according to the invention comprises a dry matter content of 70 to 90 wt-%, in particular 75 to 90 wt-%, in particular 75 to 85 wt-%.

In particular, the present invention solves the underlying problem by providing a nutritional product comprising a shell containing a, preferably consisting of a, fat-and-carbohydrate mixture, and a core that is at least partially covered by the shell, wherein the core exists in a gel-like consistency and comprises an amount (each based on the total weight of the core) of

a) a protein component from 0.5 to 10 wt-%, in particular 3 to 9 wt-%, in particular 1 to 5 wt-%, preferably 2 to 4 wt-%, more preferably 3 to 4 wt-%,

b) a carbohydrate component from 40 to 82 wt-%, in particular 50 to 82 wt-%, in particular 50 to 70 wt-%, preferably 65 to 82 wt-%,

c) water from 10 to 50 wt-%, in particular 10 to 40 wt-%, in particular 10 to 35 wt-%, preferably 10 to 30 wt-%, and, in an optional embodiment,

d) a stimulant mixture of taurine and caffeine from 0.20 to 8.0 wt-%, in particular 0.3 to 6.0 wt-%, preferably 0.35 to 4.0 wt-%.

In an especially preferred embodiment, such a nutritional product is provided, wherein the fat-and-carbohydrate mixture is a cocoa mixture.

The present invention preferably solves the underlying technical problem by in particular providing a nutritional product comprising a shell containing a, preferably consisting of a, cocoa mixture, and a core that is at least partially covered by the shell, wherein the core exists in a gel-like consistency and comprises an amount (each based on the total weight of the core) of components a) through d), namely an amount of

a) a protein component from 0.5 to 10 wt-%, in particular 3 to 9 wt-%, in particular 1 to 5 wt-%, preferably 2 to 4 wt-%, more preferably 3 to 4 wt-%,

b) a carbohydrate component from 40 to 82 wt-%, in particular 50 to 82 wt-%, in particular 50 to 70 wt-%, preferably 65 to 82 wt-%,

c) water from 10 to 50 wt-%, in particular 10 to 40 wt-%, in particular 10 to 35 wt-%, preferably 10 to 30 wt-%, and, in an optional embodiment,

d) a stimulant mixture of consisting essentially of, preferably consisting of [sic] of taurine and caffeine in an amount of from 0.2 to 8.0 wt-%, in particular 0.3 to 6.0 wt-%, preferably 0.35 to 4.0 wt-%.

The invention provides a teaching which surprisingly and advantageously provides an organoleptic, in particular attractive nutritional product with regard to taste and appearance, in particular a confectionery product that exhibits high storage stability. This nutritional product is characterized in one embodiment of the present invention by an effect which stimulates the consumer. In an especially preferred embodiment, the preferred stimulant component is the stimulant guarana. In an especially surprising and advantageous manner, the present invention provides the advantage that despite the high preferred concentration of guarana of 0.20 to 8.0 wt-%, in particular 0.3 to 6.0 wt-%, preferably 0.35 to 4.0 wt-% according to the invention, the nutritional product according to the invention exhibits surprisingly good taste with no or only a very slightly bitter taste. In particular, by providing the core composition, which exists in an especially advantageous gel-like consistency, coated by a shell, preferably a solid shell, made of a fat-and-carbohydrate-containing mixture, in particular a cocoa mixture, an extremely appealing organoleptic product is obtained which can advantageously be consumed in situations of active motion without any problem, unlike stimulating beverages, for example, and which also exhibits high storage stability under changing environmental conditions. The core, which is coated with a shell, preferably constructed of chocolate, and which exists in gel-like consistency provides an especially attractive eating experience in precisely this combination with the preferably solid shell, preferably containing a cocoa mixture. The present teaching therefore provides a food product which is characterized by its special qualitative and quantitative composition, the food product appealing to the consumer by the product's special combination of the rheology of its core and the consistency of its shell in an especially advantageous manner with regard to organoleptics and optics. In a preferred embodiment, the present teaching provides a vitalizing function caused not just by the special qualitative composition, optionally characterized by the presence of taurine and caffeine, but also by an attractive organoleptics which is supported by the special rheology of the product.

According to the invention, the preferred stimulant mixture preferably comprises only the components taurine and caffeine. In another embodiment, the stimulant mixture used according to the invention comprises essentially of taurine and caffeine. In another preferred embodiment, the stimulant mixture used according to the invention consists essentially of taurine and caffeine.

According to the invention, the ratio (based on weight) of taurine to caffeine in the nutritional product is preferred to be >1 in the core and/or in the stimulant mixture, in particular >5, preferably 8 to 14, preferably 12 to 13, in particular 12.5. It is especially preferred for a mixture of taurine and caffeine to be used, said mixture having 12.5 parts by weight taurine and 1 part caffeine, i.e. a ratio cf.

In an especially preferred embodiment, the fraction of taurine and caffeine based on the total weight of the nutritional product is 0.2 to 5.5 wt-%, preferably 0.3 to 4.0 wt-%, preferably 0.35 to 5.0 wt-%, in particular 0.35 to 3.0 wt-% (each based on the total weight of the core and shell).

In an especially preferred embodiment of the present invention, in addition to the components a), b), and c) in the core of the nutritional product according to the invention, or in one embodiment of the present invention, in addition to the components a), b), c) and d), at least one other additional component e) is contained, namely at least one additive. This at least one additive can preferably be one or more substances selected from the group consisting of alcohol, encapsulated effervescent powder, effervescent powder, powdered milk, powdered yogurt, flavorings, minerals, trace elements, pieces of fruit, coloring agents, nutritionally-compatible acids such as citric acid, preservatives, vitamins, fillers, gelling agents, emulsifiers and swelling agents. In a preferred embodiment, the alcohol additive can be a potable alcohol, in particular ethanol. In a preferred embodiment, the additive can be an effervescent powder present in the form of capsules or granulates.

In a preferred embodiment, the additive component e) in the core can be present in an amount of from 0.01, preferably 0.1 to 44, preferably from 0.1 to 30, preferably 0.1 to 20, preferably 0.1 to 10 wt-%, preferably 1 to 6 wt-% (in each case based on the total weight of the core).

In one embodiment, it can also be that components a) to c), or in another embodiment components a) through d), are the only components in the core.

In an especially preferred embodiment, the present invention relates to a nutritional product comprising a shell containing a cocoa mixture and a core that is at least partially covered by the shell, wherein the core is present in a gel-like consistency and comprises an amount (each based on the total weight of the core) of a) a protein component of from 2 to 4 wt-%, b) a carbohydrate component of from 65 to 82 wt-%, c) water from 10 to 30 wt-% and, in an optional embodiment, d) a stimulant mixture of taurine and caffeine of from 0.35 to 4 wt-%. It is preferred that no other components are present in the core, in particular no additives and/or fillers. However, an additional component e) can be provided in the core, preferably in an amount of from 1 to 6 wt-%. In a preferred embodiment, solid or liquid fillers can be present in the core.

In connection with the present invention, a carbohydrate is understood to mean, in particular, a mono-, di-, oligo- or polysaccharide or a sugar alcohol, in particular a polyol. It is preferred that the term “carbohydrate” is understood to mean a sugar, in particular a mono- or disaccharide, preferably saccharose, glucose or fructose.

In connection with the present invention, “organoleptic” is understood to mean one or more properties of a nutritional product which act on the sensory organs of a consumer, in particular taste, appearance, color or smell of the nutritional product.

In connection with the present invention, a nutritional product is understood to mean a product that serves the purpose of human or animal, preferably human, nutrition and of enjoyment, preferably by mouth. In connection with the present invention, foods include nutrients or luxury foods in particular, preferably confectioneries. In an especially preferred embodiment, the nutrients or luxury foods are in solid form, in particular in a solid and spatially defined form, and therefore do not represent any beverages, powders, pastes or creams. In connection with the present invention, a solid and spatially defined form is understood to mean a form wherein the nutritional product exhibiting this spatially defined form no longer changes its defined form when properly handled professionally until it is eaten. In an especially preferred embodiment, the foods, in particular the nutrients or luxury foods exist in the form of tablets, sticks, rods, wafers and preferably bars, in particular energy bars, athletes bars, chocolate bars or fitness bars.

In connection with the present invention, caffeine is understood to mean 1,3,7-trimethylxanthine, also occasionally called methyltheobromine, theine or guaranine.

In connection with the present invention, taurine is understood to mean 2-aminoethanesulfonic acid (C₂H₇NO₃S).

In connection with the present invention, a core in a gel-like consistency is preferred to mean that the core exists as a gel. In connection with the present invention, a gel is defined as a finely-dispersed system made up of at least one solid and one liquid phase and preferably represents a colloid. In connection with the present invention, a core in gel-like consistency is a viscoelastic core. In advantageous fashion and in a preferred embodiment, the storage module amount of the core in gel-like consistency is larger than that of the loss module, in other words the elastic characteristics of the core outweighs the viscous characteristics thereof. In connection with the present invention, the storage module is understood to mean the stored stress and the loss module is understood to be the stress which is dissipated.

In connection with the present invention, a gel-like consistency is preferably understood to mean a firm consistency. In connection with the present invention, a gel-like consistency is preferably a consistency that exhibits mostly elastic, preferably elastic, behavior. A core according to the invention is preferably not creamy.

In particular, a core in gel-like consistency in connection with the present invention is understood to mean a core in gel form, in particular a core with a compressive strength of 50 to 4000 N/m², in particular 100 to 3500 N/m², preferably 500 to 3000 N/m², in particular 1000 to 2500 N/m², preferably 2000 to 2500 N/m², in particular 2300 to 2400 N/m². According to the invention, the compressive strength is preferably determined using the TAXT2 texture analyzer testing device with a maximum load of 5 kg. To perform the measurement, the test specimen (a cylinder with d=12.5 mm) is inserted 4 mm into the sample and the force is measured. According to the invention, the mass of the core is preferred to have increased strength. The preferably increased strength of the gel results at the same time in a stabilization of the shell and a better bite sensation.

If in connection with the invention a composition, a product or a product component is defined by its composition, in particular quantitatively in the form of relative weight or amount specifications for one or more ingredients thereof, it is understood that the total amount or weight of the respective ingredients of the composition, product or product component add up to 100 wt-% based on the composition, product or based on the components thereof under consideration.

In an especially preferred embodiment, the invention provides that the stimulant component, in particular the stimulant mixture, in particular the stimulant mixture consisting of taurine and caffeine, is only present in the core. In a preferred embodiment, the stimulant component, in particular the stimulant mixture, does not exist in the preferably cocoa-containing shell.

In another preferred embodiment, the core exists in gel-like consistency and it is only this core which is coated by the shell according to the invention, in particular there are no other elements within the shell or the core, in particular no fluid components, in particular no filler or the like present in the nutritional product according to the invention. In an especially preferred embodiment, the core represents a single uniform mass, in particular the core does not exist in compartmented or otherwise sectioned form. Accordingly, in an especially preferred embodiment of the present invention, the shell which seals off the nutritional product from the outside comprises a single, non-compartmented core.

In an especially preferred embodiment of the present invention, the protein component a) can be a protein or at least one protein, for example two, three or more proteins. In an especially preferred embodiment, the nutritional product is a nutritional product in which the protein component, in particular the protein, is gelatin. In a preferred embodiment, the protein component, in particular the protein, is a whey protein, in particular a highly gelling whey protein. In an especially preferred embodiment, at least one protein, for example two, three, four or more different proteins, is present in the core as a protein component. In an especially preferred embodiment of the invention, only one single protein is present, in particular gelatin, in the core as a protein component. In a preferred embodiment, no other proteins other than gelatin are present in the core. In an especially preferred embodiment, the gelatin used is pork gelatin, in particular bone or rind gelatin. In another preferred embodiment, the gelatin used is bovine gelatin. In another preferred embodiment, the gelatin used has a Bloom value of preferably 150 to 300 Blooms, in particular 170 to 290 Blooms, in particular 200 to 280 Blooms and in particular 220 to 260 Blooms.

In an especially preferred embodiment, the present invention relates to a nutritional product of the type mentioned, wherein carbohydrate component b) can be a carbohydrate or at least one carbohydrate, for example two, three or more carbohydrates. In a preferred embodiment, two different carbohydrates are used in the core.

In a preferred embodiment, the present invention relates to a nutritional product, wherein the carbohydrate component exists in the form of a crystalline and a non-crystalline carbohydrate phase.

In an especially preferred form, the present invention relates to a nutritional product as mentioned, wherein the crystalline carbohydrate phase is crystalline saccharose, crystalline glucose or both. In a preferred embodiment, the non-crystalline carbohydrate phase is a carbohydrate syrup in particular, especially glucose syrup, invert sugar syrup, high fructose corn syrup (HFCS) or a mixture of two or three of these syrups.

In an especially preferred embodiment, the crystalline carbohydrate phase is made up of crystalline saccharose and crystalline glucose. In another preferred embodiment, the non-crystalline carbohydrate phase is made up of glucose syrup. In another preferred embodiment, the carbohydrate component b) is made up of a crystalline carbohydrate phase comprising crystalline saccharose and crystalline glucose and a non-crystalline carbohydrate phase comprising glucose syrup, wherein the two phases are preferably mixed together.

In an especially preferred embodiment, the core has an a_{w} value (water activity) of 0.6 to 0.9, preferably 0.65 to 0.85, in particular 0.70 to 0.75.

In another preferred embodiment, the core has a pH of 1.5 to 6.0, preferably 2.0 to 5.0, in particular 2.8 to 3.5.

In another preferred embodiment, the nutritional product is a product whose core is fat-free.

In another preferred embodiment, the nutritional product has a fraction of 20 to 40 wt-%, preferably 25 to 35 wt-%, preferably 33 wt-% shell and a 60 to 80 wt-%, preferably 65 to 75 wt-%, preferably 67 wt-% core (each based on the total weight of the product).

In an especially preferred embodiment of the present invention, the nutritional product has a fraction of 50 to 95 wt-% shell, in particular 40 to 70 wt-% shell, to 5 to 50 wt-% core, preferably 30 to 60 wt-% core (in each case the total weight of the core or shell relative to the total weight of the product). In an especially preferred embodiment, the nutritional product has a fraction of 50 to 70 wt-%, preferably 60 to 70 wt-% shell, and 30 to 50 wt-% core, preferably 30 to 40 wt-% core (in each case the total weight of the core or shell relative to the total weight of the product).

In an especially preferred embodiment, the nutritional product according to the invention is characterized by a ratio of gel diameter, i.e. the core diameter, to the shell thickness of (1.5 to 3):1.

The present invention provides that the core of the nutritional product is covered at least partially, preferably completely, by a shell containing a, preferably comprising a, fat-and-carbohydrate mixture, in particular a cocoa mixture. Preferably, the shell is solid, in particular firm to the bite.

In connection with the present invention, a fat-and-carbohydrate mixture is a mixture of fat and carbohydrates, in particular mono- and/or disaccharides that contributes to the formation of a solid food shell and optionally comprises additives such as flavorings, but can also exist without these.

In a preferred embodiment, the fat-and-carbohydrate mixture can be understood to be a fatty glaze, in a preferred embodiment therefore it can be a mixture of fats and carbohydrates, in particular mono- or di-saccharides that are suitable for coating nutritional products and can exist in a form that does or does not include cocoa. In the case of a non-cocoa-containing fatty glaze, the cocoa component present in the cocoa-containing fatty glaze is replaced by vegetable fats.

In connection with the present invention, a cocoa mixture is understood to mean chocolate and cocoa-containing fatty glazes in particular. In connection with the present invention, cocoa-containing fatty glazes are compositions that comprise cocoa-containing components and fat in addition to carbohydrates, but no cocoa butter. In an especially preferred embodiment, the cocoa mixture contained in the shell, or which forms it, is chocolate.

In connection with the present invention, “chocolate” is understood to mean a coco-containing composition that can also contains fat, carbohydrates and optionally proteins in addition to cocoa in the form of cocoa butter or in the form of cocoa butter and cocoa paste, optionally also in the form of cocoa powder. In connection with the present invention, a “couverture” is understood to mean a chocolate, in general having a higher fat content, used for glazing in particular. In connection with the present invention, chocolates are understood to mean specifically white chocolates as well, in other words chocolates that only contain cocoa butter as a cocoa-containing component, but not the cocoa paste or cocoa powder, in addition to milk chocolates which also contain milk components in addition to the cocoa-containing component and carbohydrates, as well as bitter chocolates which generally contain no milk components along with the cocoa-containing component and carbohydrate component.

In an especially preferred embodiment, the nutritional product comprises at least one flavoring in the core, in the shell or in both, in particular in the cocoa mixture. In connection with the present invention, a flavoring is understood to also mean a spice. In an especially preferred embodiment, the at least one flavoring is a fruit flavor, for example a cherry flavor, chili, thyme, pepper or cinnamon. The flavoring can also be an alcohol, in particular a potable alcohol.

According to another preferred embodiment, at least one coloring agent can be present in the core, in the shell or in both. In an especially preferred embodiment, the shell can be transparent and the core can be colored, in particular black, white, yellow, red, green, or blue. In another preferred embodiment, the shell can be non-transparent for example black, white, brown or dark brown, and the core can be transparent or colored, for example black, white, yellow, red, green, or blue. In another preferred embodiment, both the shell and the core can be transparent. For example, in a preferred embodiment, the shell can be black and the core can be white or vice versa.

In an especially preferred embodiment, the present invention relates to a nutritional product as mentioned above, wherein said product contains 11 to 50 volume-%, preferably 15 to 50 volume-%, in particular 15 to 45 volume-%, preferably 11 to 40 volume-%, in particular 15 to 35 volume-%, in particular 18 to 30 volume-%, preferably 19 to 25 volume-%, in particular 20 volume-% gas in the core (volume-% gas is based on the total volume of the core).

In an especially preferred embodiment, the gas can exist in the form of a gas mixture, such as air, in particular purified air, or nitrogen.

In an especially preferred embodiment, the present invention therefore provides a nutritional product that is characterized by a defined amount of a gas added in tailored fashion for reducing the specific density of the core and thus causes the core to foam. The especially preferred embodiment according to the invention, according to which the core comprises a specifically defined added gas portion, leads to an especially preferred, attractive organoleptics of the nutritional product, results in an especially advantageous rheology and viscosity of the core and also advantageously affects the color of the core. In particular, when using components of the core that, depending on the concentration thereof lead to color effects, for example dark color effects, that are undesirable to the consumer, for example stimulants such as guarana, the preferred embodiment according to the invention which provides for a specific amount of gas in the core can change the color effect, in particular to help give it a brighter visual appearance.

In an especially preferred manner according to the invention, while the core is being produced the gas is added continuously or batch-wise into the gel that constitutes the core, in particular before it gelling of said gel.

In an especially preferred embodiment, the nutritional product according to the invention therefore has a defined amount of gas, in particular an amount of air, the gas being introduced using a gas addition step, in particular an air addition step, as part of the production process.

However, the invention also relates to nutritional products that were produced without the aid of an addition gas addition step, in particular an air addition step, and accordingly do not include an additional gas addition and thus no additionally added, defined amount of gas in the core. The gas fraction is such nutritional products of the present invention is from 0 to 10 vol.-% in the core.

In an especially preferred embodiment, the density of the core characterized by a defined additional gas addition, i.e. a defined increase in gas content, is from 0.8 to 1.15 g/ml, in particular 0.9 to 1.15 g/ml, in particular 1.0 to 1.1 g/ml. In an especially preferred embodiment, the density of the core without any additional gas addition is from 1.2 to 1.4 g/ml, in particular 1.25 to 1.35 g/ml.

In an especially preferred embodiment, a gas bubble size distribution, in particular an air bubble size distribution with a d50 value of 50 to 300 μm, preferably 100 to 200 μm, in particular 150 to 180 μm, preferably 170 μm exists in a core having an increased gas content.

In connection with the present invention, the d50 value is understood to be the gas bubble diameter at which 50% of the volume of the gas phase in the core is represented by gas bubbles that have a diameter above the d50 value and 50% of the volume of the gas phase in the core is represented by gas bubbles with a diameter of less than the indicated d50 value.

In an especially preferred embodiment, the diameter of the gas bubbles, in particular air bubbles, in a core with an increased gas content is 1 to 800 μm, preferably 5 to 600 μm, in particular 5 to 400 μm.

In an especially preferred embodiment, the gas bubble size distribution, in particular the air bubble size distribution is determined through an optical evaluation by way of microscopic photographs. In an especially preferred embodiment, the gas fraction in the core is determined through a density determination.

The present invention also relates to a method for producing a nutritional product comprising a shell containing a fat-and-carbohydrate mixture, preferably a cocoa mixture, and a core that is at least partially covered by the shell, said core being of gel-like consistency, in particular a method for producing said nutritional product according to the invention, wherein the method comprises the following process steps, preferably in the order indicated:

x) Preparing a pre-formed shell of a fat-and-carbohydrate mixture, in particular a cocoa mixture,

y) Preparing a liquid composition, preferably a heated or warmed liquid composition, with an amount (the weight of the respective components indicated is based on the total weight of the liquid composition) of

a) a protein component of 0.5 to 10 wt-%, in particular 3 to 9 wt-%, in particular 1 to 5 wt-%, preferably 2 to 4 wt-%, preferably 2 to 3 wt-%,

b) a carbohydrate component from 40 to 82 wt-%, in particular 50 to 70 wt-%, preferably 65 to 82 wt-%,

c) water from 10 to 50 wt-%, in particular 10 to 40 wt-%, in particular 10 to 35 wt-%, preferably 10 to 30 wt-%, and, in an optional embodiment,

d) an optional caffeine-containing stimulant component, in particular a stimulant mixture consisting essentially of, preferably consisting of a caffeine-containing stimulant, in particular taurine and caffeine, wherein the caffeine-containing stimulant component is used in an amount of preferably from 0.20 to 8.0 wt-%, in particular 0.5 to 4.0 wt-%, preferably 0.35 to 4.0 wt-%,

z) Fill the composition into the shell, cool and seal the same.

In a preferred embodiment, in addition to the components a) to c), or a) to d), the additional component e) can be provided in the liquid composition.

In an especially preferred embodiment of the present invention, the method accordingly provides said steps x), y) and z), wherein in step y) components a), b) and c) are provided in the form of a liquid mixture, in particular a heated liquid mixture.

In an especially preferred embodiment of the present invention, the liquid mixture of components a), b) and c), and optionally d), prepared in process step y) is impinged by a gas, in particular a gas mixture, preferably air or nitrogen, in such a way that an addition of gas, in particular a defined gas addition, occurs and such that the resultant liquid composition has a gas content that is significantly above that of a method which does not involve this air addition step. This preferred gas addition step according to the invention can be done as part of process step y) or immediately thereafter. In an especially preferred embodiment, the gas addition step is carried out continuously or discontinuously. In an especially preferred embodiment, the gas addition step is carried out through the addition of gas, for example by way of a rotor, a rotor/stator, a nozzle or a nozzle system, or through impaction, for example by way of impellers, rotors or a stirrer.

In an especially preferred embodiment, the present invention provides a method for adding gas to the liquid composition prepared according to process step y), in particular in a defined amount, in particular such that a gas content of 1 to 50 volume-%, preferably 5 to 50 volume-%, in particular 5 to 45 volume-%, preferably 10 to 40 volume-%, in particular 15 to 35 volume-%, in particular 18 to 30 volume-%, preferably 19 to 25 volume-%, in particular 20 volume-% gas (each volume-% gas is based on the total volume of the core) exists in the core of the nutritional product obtained.

According to the invention, the sequence of process steps x) and y) can also be exchanged. In a preferred embodiment, in step z) in particular, the shell is not sealed until after the filled, liquid composition is cooled. During the cooling process, the liquid consistency of the core is converted to a gel-like consistency in a controlled manner.

In an especially preferred embodiment, step y) is carried out by dissolving the protein component in water under heating in a step y1), preferably under heating at a temperature of 50 to 110° C., in particular 50 to 60° C., preferably 60° C., the carbohydrate component, the optional additives and the optional stimulant mixture are mixed in a step y2) carried out simultaneously or successively, said step preferably performed at a temperature of 60 to 110° C., in particular 75 to 95° C., in particular 90° C., under heating and addition of water and in a step y3) the protein component-containing solution according to y1) is mixed with the preferably stimulant-containing solution obtained in step y2) and optionally is then cooled, preferably to a temperature of 20 to 40° C., in particular 30 to 35° C., preferably 32° C.

In an especially preferred embodiment of the present invention, the protein component, preferably gelatin, is first mixed with water in step y1) at a temperature of 5 to 30° C., preferably 10 to 25° C., in particular 20° C., preferably for a mixing and swelling time of 10 to 90 minutes, preferably 15 to 60 minutes, preferably 20 minutes.

Then, in this step y1), in a preferred embodiment the protein component mixed with water is heated to 50 to 110° C., preferably 55 to 80° C., preferably 60° C., wherein the solution is preferred to be held at this temperature for a period of 1 to 60 minutes, preferably 3 to 30 minutes, preferably 5 minutes.

In another preferred embodiment, the mixed and heated, preferably stimulant-containing, solution according to step y2) is then held for a time period of 1 to 120 minutes, preferably 10 to 120 minutes or preferably used in the process immediately.

In another preferred embodiment, the protein component-containing solution according to step y1) and the preferably stimulant-containing solution according to step y2) are mixed together in a preferred embodiment for a time period of 5 to 60 minutes, preferably 10 to 50 minutes, in particular 10 minutes.

In another preferred embodiment, the liquid core composition produced in step z) according to the invention is added to the shell comprising the fat-and-carbohydrate-containing material, in particular cocoa-containing material, at a temperature of 20 to 40° C., preferably 22 to 38° C., in particular 32° C. In an especially preferred embodiment, a cooling phase and optionally, and especially preferred, a quiescent phase can then be provided. In an especially preferred embodiment, the cooling phase is carried out at a temperature of 15 to 25° C., preferably 20° C. In another preferred embodiment, the subsequent quiescent phase is carried out for a time period of 1 to 10 hours, preferably 2 to 6 hours, in particular for 300 minutes.

In another alternative embodiment, instead of the cooling and subsequent quiescent phase, a freezing and subsequent quiescent phase can be carried out. In this preferred embodiment, a freezing phase is carried out at temperatures of −15 to 0° C., preferably −10 to −3° C., in particular −4° C. In a preferred embodiment, the subsequent quiescent phase can be carried out for a time period of 1 to 60 minutes, preferably 1 to 30 minutes, in particular 1 minute.

In another preferred embodiment, after the core composition added to the shell is cooled, preferably after the required gel-like consistency is formed, the filled, pre-formed shell is sealed, for example with chocolate glaze or fatty glaze. In an especially preferred embodiment, the sealing cover or base is poured at a temperature of 34 to 60° C., preferably 35 to 50° C., in particular 38° C.

In an especially preferred embodiment of the present invention, the invention also relates to a nutritional product, preferably a bar, for example an energy bar with a vitalizing filling or a children's bar, in particular of the composition and type defined above, wherein said bar is preferable to be producible, and in particular is produced, according to one of the methods of the present invention.

Other preferred embodiments of the present invention can be found in the dependent claims.

The invention is explained below in more detail with the aid of the examples and associated figure.

The figure graphically shows the results of a taste test of a bar with a vitalizing filling in the form of a spider web evaluation diagram.

Example 1—Energy Bar with Taurine and Caffeine Recipe

TABLE 1
Component

Saccharose, crystalline
Water
Glucose, crystalline
Glucose syrup
Stimulant mixture (caffeine, taurine)
according to Table 2
Additional components according to
Table 2
Gelatin, 200 Bloom
Citric acid
Flavoring
Trisodium citrate
Coloring agent
Total

Recipe of a mixture comprising a stimulant mixture (taurine and caffeine) and additional components

TABLE 2
summary of the stimulant mixture and additional components

| Component | % |
|---|---|
| Taurine | 55.25 |
| Caffeine (anhydr.) | 4.42 |
| Vitamin B6 (pyridoxine hydrochloride) | 0.28 |
| Vitamin B12 (cyanocobalamin 0.1%) | 0.00028 |
| Niacin (nicotinamide) | 1.0 |
| Pantothenic acid (as calcium-D- | 0.28 |
| pantothenate) | |
| Glucuronolactone | 33.15 |
| Inositol (NF12) | 2.76 |
| Glucose, monohydrate | 2.76 |
| Total | 100 |

Example 2—Bar with Vitalizing Filling Comprising Guarana Recipe:

TABLE 3
Raw material

Saccharose
Water
Glucose, crystalline
Glucose syrup
Guarana extract
Gelatin 210 Bloom
Citric acid
Flavoring
Trisodium citrate
Coloring agent
Total

Gelatin Mass:

In deviation to the Example 1 recipe, in the Example 2 recipe the separate water phase was used right at the beginning to disperse the guarana. After the guarana is evenly distributed, the gelatin is added to produce swelling. Then, heating is done to a temperature in the range of 58 to 62° C.

Sugar Mass:

Sugar, residual water phase, dextrose and glucose syrup are heated to a temperature in the range of 86 to 92° C. Then, the mass is held at that temperature for a time of 2 to 4 min. until all sugar crystals have visually dissolved.

Then, the remaining additives are added (up to the flavoring) and cooling is done to a temperature in the range of 73 to 78° C. When this temperature is reached, the flavoring is added and cooling is continued to a temperature in the range of 30 to 35° C.; then, air is impacted, filling is done at a temperature in the range of 30 to 33° C.

Example 3—Production Method for the Core Based on the Recipe According to Example 1 (percent data are based on the total recipe):

allow 1 part gelatin with 3 parts water to swell in glass beaker 1 for 15 to 25 min., and then heat to a temperature in the range of 58 to 62° C.

add 2 parts water to glass beaker 2.

add 5 parts glucose syrup to glass beaker 2.

add 12 parts saccharose, 2 parts glucose (crystalline), caffeine-containing and taurine-containing mixture from Table 2, 0.9 to 1.3 citric acid, 0.05 to 0.3% trisodium citrate, 0.005 to 0.02% coloring and 0.6 to 1.0% flavoring to glass beaker 2.

heat the entire batch in glass beaker 2 to a temperature in the range of 83-88° C.

add the tempered gelatin.

final temperature of the filling: 75-81° C.

Alternatively, the gelatin can be distributed with water using a stirrer, allowed to swell for 18 to 24 min. and then heated to a temperature in the range of 58 to 62° C. The other contents of the core are mixed, dissolved while stirring and heating. Then, the gelatin solution heated to a temperature in the range of 58 to 62° C. is added and after cooling to a temperature in the range 29 to 32° C. is filled.

Production of the Shell and the Ready-To-Eat Bar:

The chocolate shell is produced from commercial couvertures, optionally with the addition of flavoring, or is produced from chocolate.

Some of the chocolate was poured into a plastic mold and a hollow part was formed with the chocolate (shell for filling) and then the chocolate was filled with the energy bar filling above after a cooling step. Then, heating is done to a temperature in the range of 29 to 34° C.

Then, the filled hollow part mold is stored intermediately in a cool room at a temperature of 3 to 7° C.

After one hour, the mold was removed again. The filling was cooled in the meantime and had formed a slightly gelled surface. A chocolate base was then applied thereto. Due to the low temperature of the filling, the chocolate immediately hardened.

The Bars Produces Have the Following Weight Proportions:

1 part relief hollow part with base and 2 parts filling.

Rheological measurements were taken of the gel-like cores of the energy bar produced. (the testing devices is an AR 2000 oscillation rheometer, plate/plate system, measurement gap 3300 μm, torque 1000 μNm, frequency range 0.1 to 10 Hz, d=5 cm). The results show that in the low frequency range the storage module is much larger than the loss module, at 0.1 Hz it is 2000 Pa for the storage module and 550 Pa for the loss module.

The energy bars produced are characterized by an attractive organoleptics, a stimulating effect and good shelf-life. The produced energy bars exhibited a low a_{w} value (water activity) in particular and a low pH (based on the filling a_{w} value=0.72, the pH=0.32). They exhibited a higher storage stability at room temperature, were characterized by a desirable stiffness of the filling and at the same time a stabilization of the shell and a high stability in the un-moved state. The produced products were not sticky, did not form any threads, showed no drained filling and are very bite-able in an attractive way.

The results of the physical analysis showed a freezing point lowering at T=−48.0° C., a free water fraction of 2.66 g/100 g water and an adhesion of 5.01 kPa ±0.76 kPa (texture analyzer TAXT2, for the measurement, the test specimen (stamp with d=12.5 mm) is pressed onto the surface with a pre-force of 0.5 N and then the pull-off force is measured).

Color measurement measurement [sic] in L, a*, b* spectrum (Minolta Spectrophotometer CM-600d)

L value: 23.67, a* value 0.08, b* value 0.82

Example 4—Analytical Sensory Test

The present sensory analysis is done in order to analyze the intrinsic product characteristics (appearance, smell, taste and texture). This allows the relationship between the physical/chemical components of the product and the sensory characteristics resulting therefrom, as well as the perception thereof by the test persons, to be documented.

The profile test selected had an interval scale according to the official collection of testing methods according to § 65 of the LFGB 00.90 11/1 Sensory Testing Methods—Profile Testing Part 1: Conventional profile, May 2002 (incorporation of the German standard by the same name DIN 10967 Part 1, revised October 1999. The process scheme of the testing process was carried out according to the testing methods (Profile Test Part 1). The statistical evaluation of the featural characteristics was done using means and standard deviation. The results were represented graphically as plygons [sic] (“spider web”). All references and specifications contained in the standard (in particular other DIN standards) were adhered to and included.

The standard establishes a process for analyzing the impression (intensity) of product-related featural characteristics. In the process, the featural characteristics (such as color, smell, taste, consistency) are separately recorded in the order in which they are perceived and the intensity of each featural characteristic is determined using a predefined intensity scale.

The only persons who may test are persons who have received specific training according to ISO standards (ISO standard 8586.1-1993, 8586.2-2008 and 11035-1994) and who possess comprehensive knowledge of the language used to identify featural characteristics so that comprehensible descriptions of the product can be generated.

The entire procedure of finding suitable terms to clearly describe the product (featural characteristics) was carried out (see indicated standard) so that a special product profile could be generated. All relevant terms were listed in a collective and their impact were evaluated accordingly. Then, double-meanings and hedonistic and imprecise terms, etc., were eliminated. The final number of terms for documenting the characteristic properties of the product was established to be 6 features: crisp bite reaction of the outer shell, bitter taste impression, intense green color of the fill, sweetness, acidity and smooth gel consistency of the filling. A suitable terminology for all features described was generated this way and defined test instructions were formulated. 10 trained testers took part in the test. The test was done as a single test. Every tester independently tested the intensity of the specified featural characteristics in the order in which they occurred and entered the results into the testing form below.

The bar with the vitalizing filling according to the recipe from Example 2 was submitted to the testers for tasting.

The sensory test was carried out using interval scales (structured line).

The unstructured line has a length of 10 cm. The beginning and the end (so-called anchor points) of the line are described by the positive or negative featural characteristics (such as rough to very smooth). Then, the perceived intensities of the terms (features) are transferred by the testers to the scales. To do so, each tester marks his test results (individual perception) directly on the line at the corresponding point between the two anchor points. The evaluation is done as a arithmetic mean determination with standard deviation.

Arithmetic Mean Determination:

$$\overline{x} = \frac{1}{n} {\sum }_{i = 1}^{n} {x}_{i}$$

Standard Deviation:

$$sx = \sqrt{\frac{1}{n - 1} ( {\sum }_{i} {( {x}_{i} - \overline{x} )}^{2} )} = \sqrt{\frac{1}{n - 1} ( {\sum }_{i} {x}_{i}^{2} - n {\overline{x}}^{2} )}$$

The results are shown in the figure. The product according to the invention is characterized by a very good bite reaction, an advantageously high level of sweetness, a pleasant acidity and a filling which is found to be smooth, wherein at the same time only a small degree of bitterness was found.

1-16. (canceled)

17. A nutritional product comprising:
a shell containing a fat-and-carbohydrate mixture; and
a core at least partially covered by the shell, the core having a gel-like consistency and including:
a) a protein component of 0.5 to 10 wt-% based on a total weight of the core;
b) a carbohydrate component of 65 to 82 wt-% in the form of a crystalline and a non-crystalline carbohydrate phase based on the total weight of the core; and
c) water from 10 to 30 wt-% based on the total weight of the core.

18. The nutritional product according to claim 17, wherein the product comprises 11 to 50 volume-% gas in the core based on a volume of the core.

19. The nutritional product according to claim 17, wherein the product comprises 0.20 to 8.0 wt-% of a caffeine-containing stimulant component in the core.

20. The nutritional product according to claim 19, wherein the caffeine-containing stimulant component is selected from a group consisting of taurine, theobromine and combinations thereof.

21. The nutritional product according to claim 17, wherein the fat-and-carbohydrate mixture is a cocoa mixture.

22. The nutritional product according to claim 17, wherein the crystalline carbohydrate phase is selected from a group consisting of saccharose, glucose, isomaltulose and combinations thereof and the non-crystalline carbohydrate phase is glucose syrup.

23. The nutritional product according to claim 17, wherein the protein component is gelatin.

24. The nutritional product according to claim 17, wherein the core is fat free.

25. The nutritional product according to claim 17, wherein the nutritional product has a fraction of 50 to 95 wt-% shell and 5 to 50 wt-% core based on the total weight of the product.

26. The nutritional product according to claim 21, wherein the cocoa mixture is chocolate.

27. The nutritional product according to claim 17, wherein the core comprises at least one additive.

28. The nutritional product according to claim 17, wherein at least one of the core and the shell includes at least one flavoring.

29. A method for producing a nutritional product of claim 17, the method comprising:
x) preparing a pre-formed shell of a fat-and-carbohydrate mixture, the fat-and-carbohydrate mixture being a cocoa mixture,
y) preparing a liquid composition with amounts based on the total weight of the composition of
a) a protein component of 0.5 to 10 wt-%;
b) a carbohydrate component of 65 to 82 wt-%; and
c) water of 10 to 30 wt-%; and
z) filling the liquid composition into the shell, cooling and sealing the shell.

30. The method according to claim 29, wherein step y) is carried out through dissolving the protein component in water in a step y)(1), mixing and dissolving the carbohydrate component, the optional ad-ditives and the optional stimulant component in a step y)(2) with heating, and mixing the protein component-containing solution according to step y)(1) with the stimulant-containing solution according to step y)(2) in a step y)(3).

31. The method according to claim 29, wherein gas is added to the liquid composition according to process step y) in such a way that the core of the nutritional product obtained has gas fraction of 11 to 50 volume-% based on the total volume of the core.
